(19) United States
(12) Patent Application Publication
(10) Pub. No.: US 2013/0173510 A1
(43) Pub. Date: Jul. 4, 2013

(54) METHODS AND SYSTEMS FOR USE IN REDUCING SOLUTION CONVERGENCE TIME USING GENETIC ALGORITHMS

(71) Applicant: James Joseph Schmid, JR., Danville, CA (US)

(72) Inventor: James Joseph Schmid, JR., Danville, CA (US)

(21) Appl. No.: 13/342,341

(22) Filed: Jan. 3, 2012

(51) Int. Cl. G06N 3/12

(52) U.S. Cl. 706/13

(57) ABSTRACT

A computer system for finding a solution using a genetic algorithm is provided. The computer system includes a display, a user input device, at least one processor, and computer readable media. The at least one processor is programmed to execute a genetic algorithm. The genetic algorithm includes an initialization stage, an evolution stage, and an output stage. The evolution stage includes a domain restraint process. During the domain restraint process, children created during the evolution stage are compared with an environmental influence which represents domain knowledge. Children are influenced using the environmental influence in order to reduce the search domain by avoiding solutions known to be sub-optimal.

### BACKGROUND OF THE INVENTION

The field of the invention relates generally to genetic algorithms and, more particularly, to methods and systems for use in reducing search space and solution convergence time using genetic algorithms.

Computer monitoring and control of industrial processes facilitates precise and accurate control of control variables, such as flow rates, temperatures, voltages, and/or pressures. Such computer-controlled variables can be selectively adjusted to influence overall output productivity, emissions, efficiency, and/or component lifespan, for example. However, finding improved values for control variables may be a difficult and time-consuming task as a result of the combinatorics of multiple control variables that may exist. Thus, significant computing resources and/or time may be required to discover improved solutions.

Genetic algorithms are often used to find solutions to problems with large search domains. Genetic algorithms mimic the process of natural evolution by creating successive generations of candidate solutions, known as individuals. As each generation is created, such algorithms evaluate individuals, select pairs of individuals for additional breeding, and produce a new generation of individuals using various stochastic processes. The creation of individuals through such stochastic processes is one of the benefits of genetic algorithms and unexpected solutions are often discovered.

However, known stochastic processes may also generate unusable, undesirable, or impractical solutions. Accordingly, because such processes waste valuable computation time pursuing sub-optimal solutions, the use of genetic algorithms to produce results in real-time or near real-time may be limited.

### BRIEF DESCRIPTION OF THE INVENTION

In one embodiment, a computer-implemented method for deriving a solution using a genetic algorithm is provided. The method includes defining an individual to include at least one chromosome, creating a population of individuals, and executing, via a processor, an evolution stage until at least one predefined convergence criterion is satisfied. The evolution stage includes evaluating each individual in the population using a fitness function, creating at least one child from at least one individual selected from the population, and influencing at least one child using an environmental influence.

In another embodiment, a computer system including a display, a user input device, and at least one processor is provided. The at least one processor is configured to define an individual including at least one chromosome, create a population of individuals, and execute an evolution stage until at least one predefined convergence criterion is satisfied. To execute the evolution stage, the at least one processor is further configured to evaluate each individual in the population using a fitness function, create at least one child using at least one individual selected from the population, and influence at least one child using an environmental influence.

In another embodiment, a machine readable medium readable for use with a computer system is provided. The computer system includes a display, a user input device, and at least one processor. The medium has recorded thereon a set of instructions configured to instruct the at least one processor to define an individual including at least one chromosome, create a population of individuals, and execute an evolution stage until at least one predefined convergence criterion is satisfied. To execute the evolution stage, the medium is further configured to instruct the at least one processor to evaluate each individual in the population using a fitness function, create at least one child using at least one individual selected from the population, and influence at least one child using an environmental influence.

### BRIEF DESCRIPTION OF THE DRAWINGS

FIG. 1 is a block diagram of an exemplary computer system;

FIG. 2 is a flow diagram of an exemplary method that may be implemented using the computer system shown in FIG. 1; and

FIG. 3 is a flow diagram of an exemplary process that may be implemented using the computer system shown in FIG. 1.

### DETAILED DESCRIPTION OF THE INVENTION

The exemplary systems and methods described herein overcome at least some of the known disadvantages associated with at least some known genetic algorithms by including a domain restraint process that limits the search domain by using domain knowledge to influence known sub-optimal solutions. Moreover, the embodiments described herein provide a processor that is configured to find a solution using a genetic algorithm. The genetic algorithm includes an initialization stage, an evolution stage, and an output stage. During the initialization stage an individual is defined as containing at least one chromosome and a plurality of individuals are created as part of an initial population. During the evolution stage, the population of individuals is evaluated using a fitness function as part of an evaluation process. Moreover, during the evaluation process, if a convergence criterion is satisfied, the individual with the highest fitness will be output during an output stage. If a convergence criterion is not satisfied, the evolution stage continues with a selection process, a breeding process, and a domain restraint process, before iterating again, and starting at the evaluation process.

During the selection process, at least one individual is selected to be a parent for breeding. During the breeding process, at least two parents are combined to create a child. During the domain restraint process, the child is evaluated and influenced to ensure that the child is within given parameters. More than one child is created, and those children replace the current population or generation of individuals. The evolution stage then starts the cycle anew with the evaluation process.

The methods and systems described herein are believed to be applicable to many different problems and systems, such as circuit design, job scheduling, and financial market prediction. The exemplary embodiment described herein relates to industrial processes. Although industrial processes are described herein, the genetic algorithm described herein is in no way limited to only being used with industrial processes.

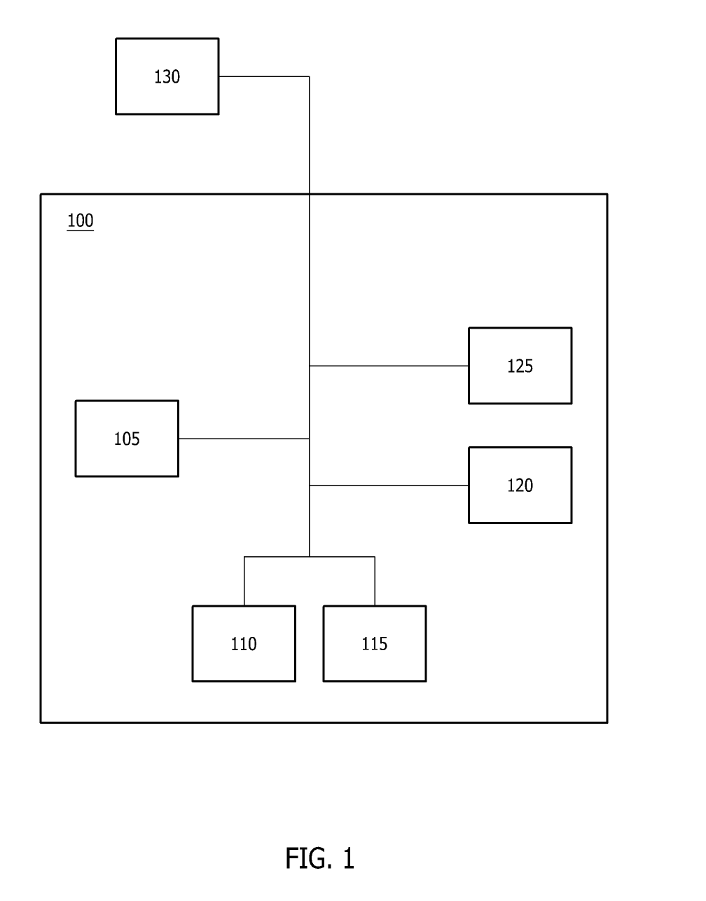

FIG. 1 illustrates an exemplary computer system 100 that may be used to implement the methods described herein, and more specifically, may be used to reduce search space and convergence time using a genetic algorithm. In the exemplary embodiment, computer system 100 includes a display 105, a processor 110, a user input device 115 such as a keyboard, a pointing device 120 such as a computer mouse or touchscreen, and computer readable media 125. Some configurations of computer system 100 may transmit signals to one or more controllers 130 that are used to control one or more aspects of a computer-controlled process, such as control variables. Controller 130 may be an actuator, a signal line, a data channel, a relay, a SCADA system, any part of a SCADA system, or the like.

Computer system 100 may include any number of processors 110 or processing units. By way of example and not limitation, computer readable media 125, or memory, comprise computer storage media and communication media. Computer storage media 125 include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media 125.

Within the computer readable media 125, instructions are written or otherwise included that configure and/or instruct processor 110 to execute a computer-implemented method as described herein.

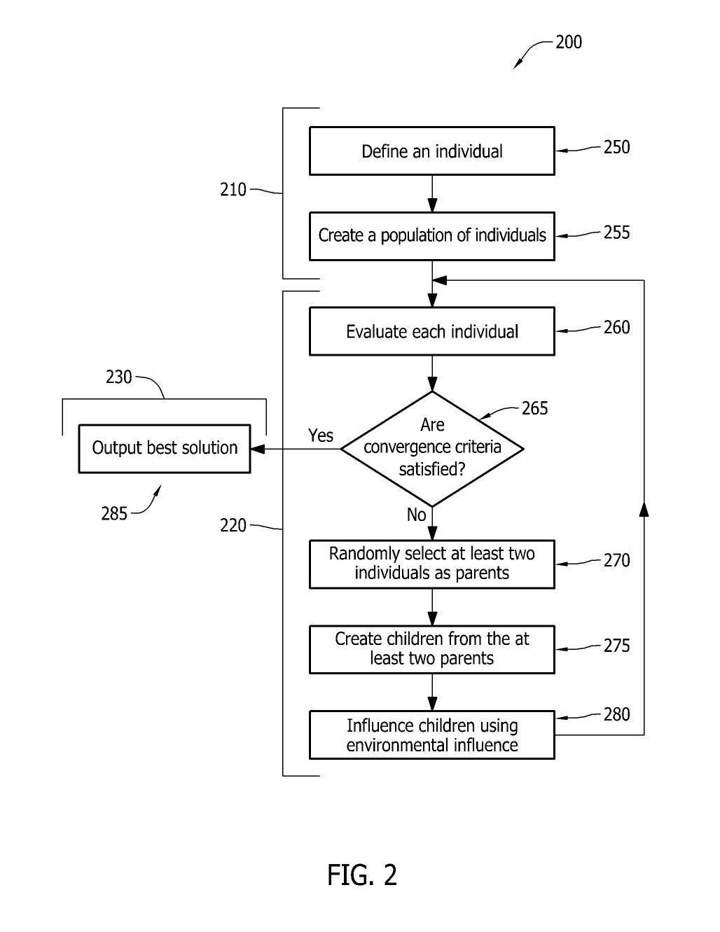

FIG. 2 illustrates a flowchart 200 of an exemplary method of reducing search space and solution convergence time. In the exemplary embodiment to implement the method, at least three stages are performed at least once. More particularly, an initialization stage 210, an evolution stage 220, and an output stage 230 are each performed at least once in the exemplary method. During initialization stage 210, an individual is defined 250. As used herein, each individual represents a possible solution to a search problem and includes at least one chromosome. A chromosome represents at least a part of a possible solution. Each chromosome includes at least one gene. A gene represents a variable, such as a control variable. For example, a gene may represent a flow rate, a temperature, a pressure, a damper position, and/or a voltage. Alternatively, a gene may represent any operational state, value, condition, input, variable, and/or control related to the problem being solved and/or the process being monitored, that is and capable of enabling the genetic algorithm described herein. Genes may have a uniform or non-uniform length depending on the representation of each variable. Regardless of gene length uniformity, the gene length is defined 250 and as such, the number of possible values or alleles for each gene is fixed. For example, three ON/OFF switches may be represented by three genes that each use one bit to represent the two alleles of “OFF” and “ON”, and thus the chromosome representing a possible solution involving the three ON/OFF switches would be three bits in length. Alternatively, in this example, the three genes may each represent 8-bit floating point numbers, and thus the chromosome would be twenty-four bits in length.

Further during initialization stage 210, an initial population, or generation, of individuals is created 255. The individuals in the initial population may be created 255 using stochastic methods or by using any other known method, such as, but not limited to, seeding.

Evolution stage 220 includes an evaluation process 260. During the evaluation process 260, execution of a fitness function is performed to determine the fitness of each individual. As used herein, the fitness of an individual depends on the problem being solved, and thus the fitness function deterministically assigns a numerical fitness to each individual based on a definition of fitness for the problem being solved. For example, if an individual is representative of various inputs to a coal boiler, such as air flow rate, air flow temperature and/or mill speeds, the fitness function may assign a fitness for the individual based on the overall output efficiency of the coal boiler. Alternatively, in such an example, the fitness function may consider both overall output efficiency and emissions, and assign the highest fitness scores to individuals that produce the greatest output efficiency and lowest emissions.

After a fitness is assigned to each individual in the population during the evaluation process 260, a convergence test 265 is applied to determine whether convergence criteria have been satisfied. If predefined convergence criteria have been satisfied, the evolution stage 220 ends and the output stage 230 begins. Convergence criteria may include, for example, a limit on the number of evolution stage iterations (i.e., the number of successive generations of individuals), and/or may include parameters defining a sufficiently optimal solution. Alternatively, convergence criteria may include any other criterion otherwise capable of enabling the genetic algorithm to function as described herein. Moreover, the phrase “convergence criteria” may refer to a single criterion. For example, after nine generations of individuals have been created 255, the pre-determined convergence criterion may cause evolution stage 220 to terminate due to convergence test 265, thus initiating output stage 230. Alternatively, a convergence criterion may include a minimum fitness threshold.

If convergence criteria have not been satisfied, then evolution stage 220 continues with a selection process 270. The selection process 270 initiates the process of creating 275 a new population, or generation, of individuals from the current population. The selection process 270 may be performed using any known method for selecting individuals, or parents, for breeding. For example, in one embodiment, parents may be selected through an elite selection process, through a roulette wheel selection process, through a rank-weighted selection process, through a random selection process, and/or any combination thereof.

Children are created from parents during breeding process 275. Children may be created 275 using any known recombination operator that generates new generations of individuals in genetic algorithms. For example, in one embodiment, recombination operators may include mutation, crossover, inversion, regrouping, colonization-extinction, and/or migration. Whether a particular recombination operator is to be applied is determined using stochastic, probabilistic, and/or deterministic means. Moreover, more than one recombination operator may be applied during the breeding process 275. For example, a child may be produced using a crossover process, prior to it being mutated.

In the exemplary embodiment, children are processed in a domain restraint process 280. During the domain restraint process 280, at least one environmental influence is applied to facilitate pruning the search space. More specifically, during the domain restraint process 280, computer system 100 evaluates, and where appropriate, modifies 280 at least one child based on a set of predefined environmental influences. As used herein, a set of environmental influences represent domain knowledge relating to the problem being solved. For example, environmental influences encode domain knowledge about particular genes, and may be represented as value ranges, relationships among genes, and/or as a function. For example, an environmental influence may encode the rule that a first gene, representative of a flow rate in liters per minute, should not exceed three. In another embodiment, an environmental influence may encode the rule that the first gene should not be less than two when a second gene, representative of the operating state of a pump, indicates that the pump is on.

It should be appreciated that the domain restraint process 280 may be implemented using any known technique for processing data structures and making modifications thereto. For example, the domain restraint process 280 may be implemented using functions, classes, plug-in modules, APIs, and/or code libraries. More specifically, the domain restraint process 280 may be added to any canonical or known genetic algorithm using known techniques to enable the genetic algorithm to function as described herein. It should also be understood that environmental influences may be stored as text files, XML files, database entries, procedures, functions, uncompiled code, compiled code, machine readable instructions, or the like.

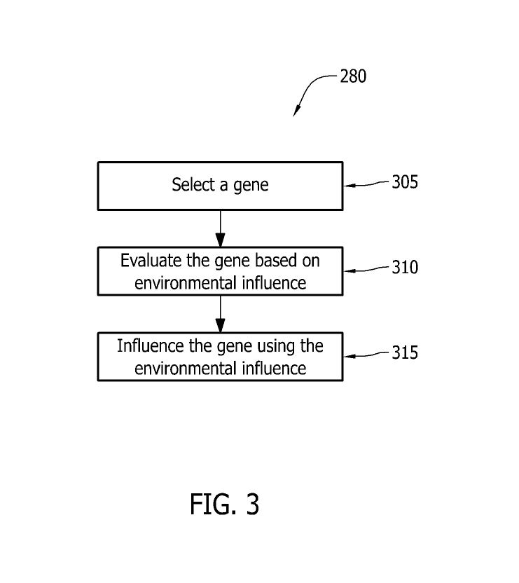

The domain restraint process 280, in the exemplary embodiment as illustrated in FIG. 3, processes an individual by selecting a first gene 305. The first gene may be selected 305 through random selection or through any other selection method that enables the genetic algorithm to function as described herein. The first gene is evaluated 310 based on a first environmental influence. More specifically, the value of the first gene is evaluated 310 for compliance with the domain knowledge encoded in the first environmental influence. The first gene may be modified or influenced 315 to ensure the first environmental influence is satisfied. In addition, or in the alternative, genes other than the first gene may be influenced 315 in order to satisfy the first environmental influence and based on the first gene. For example, based on the first environmental influence, the value of the first gene may dictate that a second gene and a third gene should have certain values. In such an example, the second gene and the third gene would be influenced 315 based on the first environmental influence.

More specifically, when a gene is influenced 315 to satisfy an environmental influence, randomness may be used to select a new value for the gene. For example, if the value of a gene is outside the range of values defined by the environmental influence, the gene may be given 315 a new value that is randomly selected from the range of values required by the environmental influence. More than one gene may be selected 305 in an individual during the domain restraint process 280, and more than one gene may be influenced 315 as a result of one or more genes being evaluated 310. More specifically, if more than one gene is to be evaluated 310, the selection 305 of the genes to be evaluated 310 and the order in which the genes are evaluated 310 may be determined randomly. Random evaluation and influence of genes decreases the likelihood of a bias being introduced from the environmental influences. Such a bias may reduce the effectiveness of the genetic algorithm described herein.

At the completion of the domain restraint process 280, the newly produced generation replaces the previous generation. Evolution stage 220 then initiates a new iteration using the newly-produced generation.

As described herein, output stage 230 begins when it is determined 265 that the convergence criteria have been satisfied during the convergence test 265. During output stage 230, the best solution is output 285. The best solution may be defined as the individual having the highest fitness value and may be identified by sorting each individual in a population based on its fitness value. Alternatively, the individuals may be sorted as part of the evaluation process 260 or the convergence test 265.

According to the exemplary embodiment, the best solution may be output 285 in either an advisory mode or a supervisory mode. In an advisory mode, the best solution is output 285 to display 105 and is readable by an operator. For example, each gene of the best solution may be displayed along with a description of what the gene represents. The operator may select the best solution under advisement and decide whether to implement the best solution.

In a supervisory mode, the best solution may be output 285 to at least one controller 130. For example, the best solution may be transmitted to at least one controller 130 at regular time intervals. Alternatively, the best solution may be output to at least one controller 130 using any known technique in order to enable the genetic algorithm described herein.

The above-described embodiments provide efficient and cost-effective methods and systems for reducing solution convergence time using genetic algorithms. A computer system is configured to perform a genetic algorithm including an environmental influence. The environmental influence reduces the likelihood of unusable and/or impractical solutions being included in the search space of the genetic algorithm.

A technical effect of the systems and methods described herein includes at least one of: (a) defining an individual to include at least one chromosome; (b) creating a population of individuals; (c) executing, via a processor, an evolution stage until at least one predefined convergence criterion is satisfied; (d) evaluating each individual in a population using a fitness function; (e) creating at least one child from at least one individual selected from a population; and (f) influencing at least one child using an environmental influence.

Exemplary embodiments of methods and systems for reducing solution convergence time using genetic algorithms are described above in detail. The methods and systems are not limited to the specific embodiments described herein, but rather, components of the systems and/or steps of the methods may be utilized independently and separately from other components and/or steps described herein. For example, the computer system and methods may also be used in combination with other computer systems and methods, and are not limited to practice with only the computer system and methods as described herein. Rather, the exemplary embodiment can be implemented and utilized in connection with many other computer systems and methods.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for deriving a solution using a genetic algorithm, said method comprising:
defining an individual to include at least one chromosome;
creating a population of individuals; and
executing, via a processor, an evolution stage until at least one predefined convergence criterion is satisfied, wherein execution of the evolution stage comprises:
evaluating each individual in the population using a fitness function;
creating at least one child from at least one individual selected from the population; and
influencing at least one child using an environmental influence.

2. A method in accordance with claim 1, further comprising defining the at least one chromosome to represent at least one control variable.

3. A method in accordance with claim 1, wherein creating a population of individuals is accomplished using at least one of random generation and seeding.

4. A method in accordance with claim 1, wherein selecting at least one individual from the population is accomplished using at least one of elite selection, roulette wheel selection, rank-weighted selection, and random selection.

5. A method in accordance with claim 1, wherein creating at least one child is accomplished using a recombination operator.

6. A method in accordance with claim 5, wherein the recombination operator is at least one of mutation, crossover, inversion, regrouping, colonization-extinction, and migration.

7. A computer system comprising:
a display;
a user input device; and
at least one processor, said at least one processor configured to:
define an individual including at least one chromosome;
create a population of individuals; and
execute an evolution stage until at least one predefined convergence criterion is satisfied, wherein to execute the evolution stage, said at least one processor is further configured to:
evaluate each individual in the population using a fitness function;
create at least one child using at least one individual selected from the population; and
influence at least one child using an environmental influence.

8. A computer system in accordance with claim 7, wherein said at least one processor is further configured to define the at least one chromosome to represent at least one control variable.

9. A computer system in accordance with claim 7, wherein said at least one processor is configured to create a population of individuals using at least one of random generation and seeding.

10. A computer system in accordance with claim 7, wherein said at least one processor is configured to select at least one individual from the population using at least one of elite selection, roulette wheel selection, rank-weighted selection, and random selection.

11. A computer system in accordance with claim 7, wherein said at least one processor is configured to create at least one child using a recombination operator.

12. A computer system in accordance with claim 11, wherein the recombination operator is at least one of mutation, crossover, inversion, regrouping, colonization-extinction, and migration.

13. A computer system in accordance with claim 7, wherein said at least one processor is further configured to output a best solution.

14. A machine readable medium readable for use with a computer system, the computer system comprising:
a display;
a user input device; and
at least one processor; said medium having recorded thereon a set of instructions configured to instruct the at least one processor to:
define an individual including at least one chromosome;
create a population of individuals; and
execute an evolution stage until at least one predefined convergence criterion is satisfied, wherein to execute the evolution stage, said medium is further configured to instruct the at least one processor to:
evaluate each individual in the population using a fitness function;
create at least one child using at least one individual selected from the population; and
influence at least one child using an environmental influence.

15. A machine readable medium in accordance with claim 14, wherein said medium is further configured to instruct the at least one processor to define the at least one chromosome to represent at least one control variable.

16. A machine readable medium in accordance with claim 14, wherein said medium is configured to instruct the at least one processor to create a population of individuals using at least one of random generation and seeding.

17. A machine readable medium in accordance with claim 14, wherein said medium is configured to instruct the at least one processor to select at least one individual from the population using at least one of elite selection, roulette wheel selection, rank-weighted selection, and random selection.

18. A machine readable medium in accordance with claim 14, wherein said medium is configured to instruct the at least one processor to create at least one child using a recombination operator.

19. A machine readable medium in accordance with claim 18, wherein the recombination operator is at least one of mutation, crossover, inversion, regrouping, colonization-extinction, and migration.

20. A machine readable medium in accordance with claim 14, wherein said medium is further configured to instruct the at least one processor to output a best solution.
